(19) United States
(12) Patent Application Publication
(10) Pub. No.: US 2004/0205646 A1
(43) Pub. Date: Oct. 14, 2004

(54) System and method to create and update an electronic photo album using a portable electronic book

(76) Inventors: James Sachs, Menlo Park, CA (US); William S. Leshner, Carlsbad, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 09/846,803

(22) Filed: Apr. 30, 2001

(51) Int. Cl. G06F 15/00

(52) U.S. Cl. 715/530; 715/515

(57) ABSTRACT

A system and method to create and update an electronic photo album using a portable electronic book. The method comprises inserting a removable storage device into a portable electronic book, the removable storage device containing electronic photographs generated by a digital camera. The method further comprises uploading the electronic photographs to an information services system. The information services including a centralized bookshelf and a personal photo albums module associated with the portable electronic book, the centralized bookshelf including electronic reading materials requested and owned by the portable electronic book. The personal photo albums module including electronic photographs owned by the portable electronic book.

### BACKGROUND OF THE INVENTION

1. Field

This invention relates generally to portable electronic books, and particularly to a system and method to create and update an electronic photo album using a portable electronic book.

2. General Background

Advances in computer and communication technology have provided consumers or users a convenient and economical way to access information in a variety of media. One particular area of information access includes electronic books. An electronic book is a virtual device that receives documents, publications, or other reading materials downloaded from an information network. Users of an electronic book can read downloaded contents of documents, publications, or other reading materials subscribed from a participating bookstore at his or own convenience without the need to purchase printed version.

Another area of technological advancement involves digital cameras capable of recording images on removable flash memory cards. Once images are recorded on a removable flash memory card, the card and images on the card become portable objects.

It is highly desirable for include image manipulation features in the electronic books to take advantage of the portability of images recorded on the removable flash memory cards.

### BRIEF SUMMARY OF THE INVENTION

A system and method to create and update an electronic photo album using a portable electronic book. The method comprises inserting a removable storage device into a portable electronic book, the removable storage device containing electronic photographs generated by a digital camera. The method further comprises uploading the electronic photographs to an information services system. The information services including a centralized bookshelf and a personal photo albums module associated with the portable electronic book, the centralized bookshelf including electronic reading materials requested and owned by the portable electronic book. The personal photo albums module including electronic photographs owned by the portable electronic book.

### BRIEF DESCRIPTION OF THE DRAWINGS

FIGS. 1A, 1B, and 1C illustrate a system in which one embodiment of the present invention can be practiced.

FIGS. 2A and 2B are diagrams illustrating an exemplary electronic book in accordance with one embodiment of the present invention.

FIG. 3 is a block diagram showing components of an exemplary electronic book.

FIG. 4 shows components used for locating, viewing, and manipulating electronic images or photographs in accordance with one embodiment of the present invention.

FIG. 5 generally outlines the process of displaying electronic images or photographs stored in a flash memory card, and adding those electronic images or photographs to a photo album in the information services system in accordance with one embodiment of the present invention.

FIG. 6 generally outlines the process of displaying or presenting electronic images to the user in accordance with one embodiment of the present invention.

FIG. 7 illustrates an exemplary configuration in which thumbnails are displayed or presented to the user via the display screen of the portable electronic book in accordance with one embodiment of the present invention.

FIG. 8 outlines the process of adding selected electronic images to a photo album in the information services system in accordance with one embodiment of the present invention.

### DETAILED DESCRIPTION OF THE INVENTION

In the following description, numerous details are merely set forth to illustrate inventive aspects of the present invention and to provide a thorough understanding of the present invention. However, it will be apparent to one skilled in the art that these specific details may not be required in order to practice the present invention. In other instances, well-known electrical structures and circuits and software modules are shown in block diagram form to avoid obscuring the present invention.

Also in the following description, “electronic publication”, “electronic documents”, and “electronic text” are used interchangeably and generally to refer to reading materials that can be read by individuals or users. “Remote viewing system”, “portable viewer”, “electronic book”, and “display device” refer to a system for viewing reading materials. “User interface”, “navigation”, “control”, and “manipulation” refer to methods for controlling the environment of the reading materials. A “page display image” is an arrangement of pixels on a display screen or an output device to create a visual representation of a page of reading material. “Rendering” and “imaging” refer to the act of arranging pixels on a display screen or an output device to create a page display image.

Typical applications may include reading materials that are of such a time-sensitive nature that publication and distribution via conventional distribution channels are not practical. Other applications may include materials consisting of a collection of text from numerous sources which are compiled in such a way as to provide value to the users or readers, materials currently out of print, and materials of highly specialized interest, limited interest or of unknown interest so as to not justify publication in printed form.

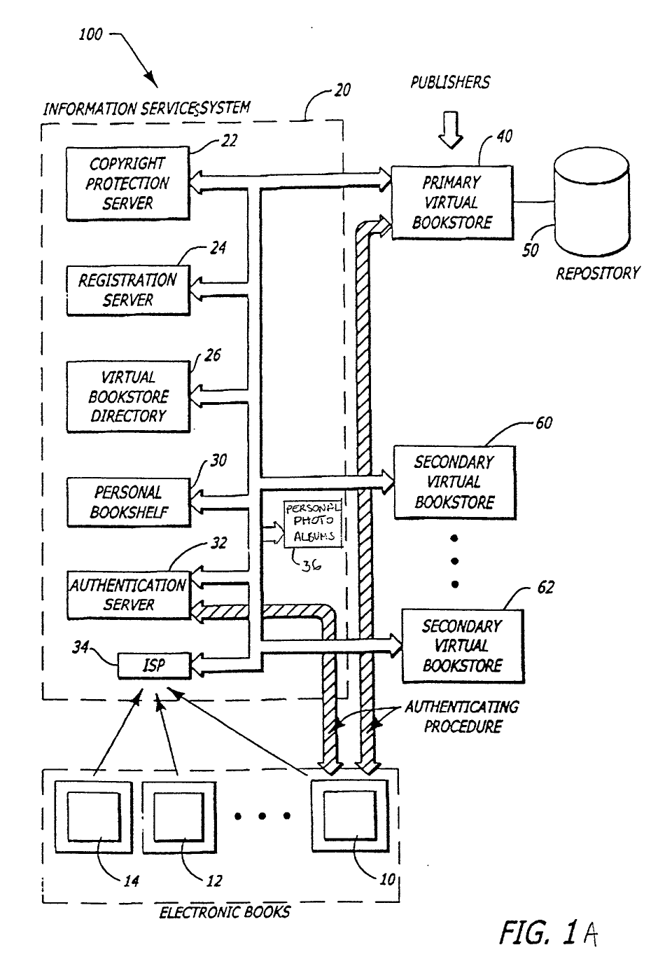

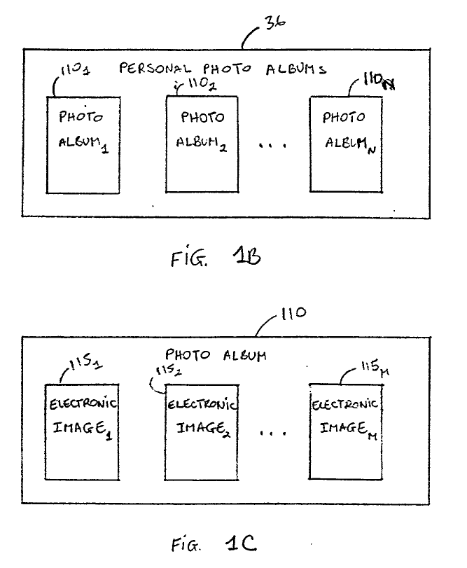

FIG. 1A is a diagram illustrating a system 100 in which one embodiment of the present invention can be practiced. The system 100 comprises: (a) at least one portable electronic book 10 operative to request an electronic document or publication from a catalog of distinct electronic reading materials, and to receive and display the requested electronic document or publication; (b) an information services system 20 which includes an authentication server 32 for authenticating the identity of the requesting portable electronic book 10 and a copyright protection server 22 for rendering the requested electronic document or publication electronic book 10; (c) at least one primary virtual bookstore 40 in electrical communication with the information services system 20, the primary virtual bookstore being a computer-based storefront accessible by the portable electronic book 10 and including the catalog of distinct electronic reading materials; and (d) a repository 50 in communication with the primary virtual bookstore for storing the distinct electronic reading materials listed in the catalog.

The system 100 preferably includes more than one portable electronic book 10 to be commercially viable. This is illustrated in FIG. 1A by including the portable electronic books 12 and 14. The system also preferably includes more than one primary virtual bookstore 40, each serving a different set of customers, each customer owning a portable electronic book 10, 12, 14.

In one embodiment of the invention, the system 100 further comprises a secondary virtual bookstore 60 in communication with the information services system 20. In this case, the information services system also includes a directory of virtual bookstores 26 in order to provide the portable electronic book 10 with access to the secondary virtual bookstore 60 and its catalog electronic reading materials.

The information services system 20 can optionally include a notice board server 28 for sending messages from one of the virtual bookstores, primary or secondary, to a portable electronic book in the system.

The information services system 20 also includes a registration server 24 for keeping track of the portable electronic books that are considered active accounts in the system and for ensuring that each portable electronic book is associated with a primary virtual bookstore in the system. In the case where the optional notice board server 28 is included in the information services system 20, the registration server 24 also allows each portable electronic book user to define his or her own notice board and document delivery address.

The information services system 100 preferably comprises a centralized bookshelf 30 associated with each portable electronic book 10 in the system. Each centralized bookshelf 30 contains all electronic reading materials requested and owned by the associated portable electronic book 10. Each portable electronic book 10 user can permanently delete any of the owned electronic reading materials from the associated centralized bookshelf 30. Since the centralized bookshelf 30 contains all the electronic reading materials owned by the associated portable electronic book 10, these electronic reading materials may have originated from different virtual bookstores. The centralized bookshelf 30 is a storage extension for the portable electronic book 10. Such storage extension is needed since the portable electronic book 10 has limited non-volatile memory capacity.

Users of the portable electronic book 10 can add marks, such as bookmarks, inking, highlighting and underlining, and annotations on an electronic publication, document, or reading material displayed on the screen of the portable electronic book, then stores his marked reading material in the non-volatile memory of the electronic book 10. The user can also upload his marked reading material to the information services system 20 to store it in the centralized bookshelf 30 associated with the portable electronic book 10, for later retrieval. It should be noted that there is no need to upload any unmarked reading material, since it was already stored in the centralized bookshelf 30 at the time it was first requested by the portable electronic book 10.

The information services system 20 further includes an Internet Services Provider (ISP) 34 for providing Internet network access to each portable electronic book in the system.

The information services system 20 further includes a personal photo albums module 36 associated with each portable electronic book 10 in the system 100. The personal photo albums module 36 is generally used to store electronic photographs or images owned by the associated portable electronic book 10. FIGS. 1B and 1C generally the organization of the personal photo albums module 36, shown in FIG. 1A. As shown in FIG. 1B, the personal photo albums module includes one or more photo albums 110₁, 110₂ . . . , 110_{N}, where “N” is a positive integer. As shown in FIG. 1C, each photo album 110 includes one or more electronic images 115₁, 115₂, . . . , 115_{M}, where “M” is a positive integer. In one embodiment, an exemplary electronic image 115₁, 115₂, . . . , 115_{M}, is represented as a JPEG (Joint Photographic Experts Group) file. Standard digital cameras are exemplary devices capable of generating JPEG files.

Each centralized bookshelf 30 contains all electronic reading materials requested and owned by the associated portable electronic book 10. Each portable electronic book 10 user can permanently delete any of the owned electronic reading materials from the associated centralized bookshelf 30.

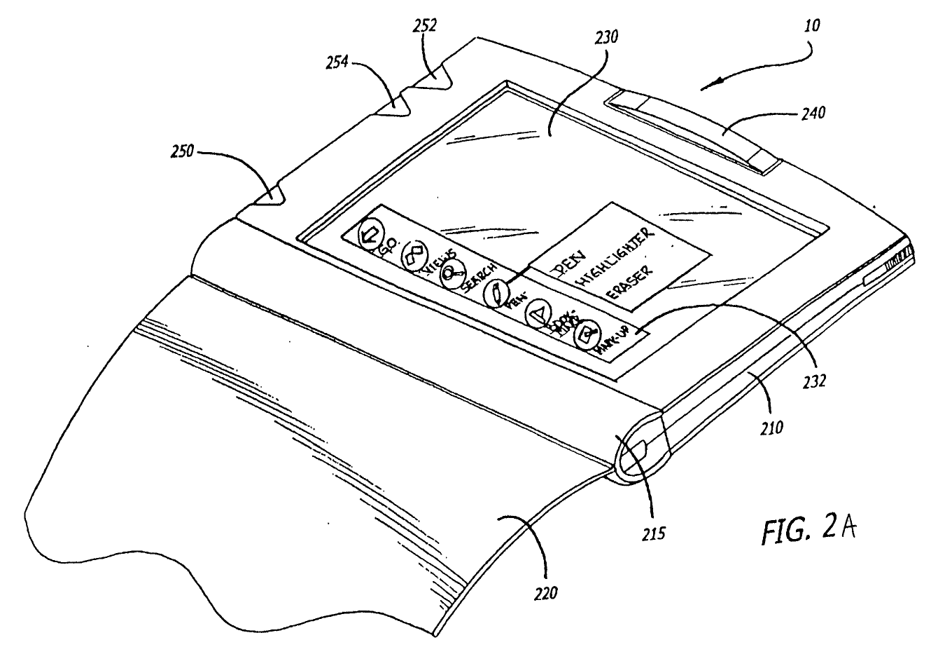

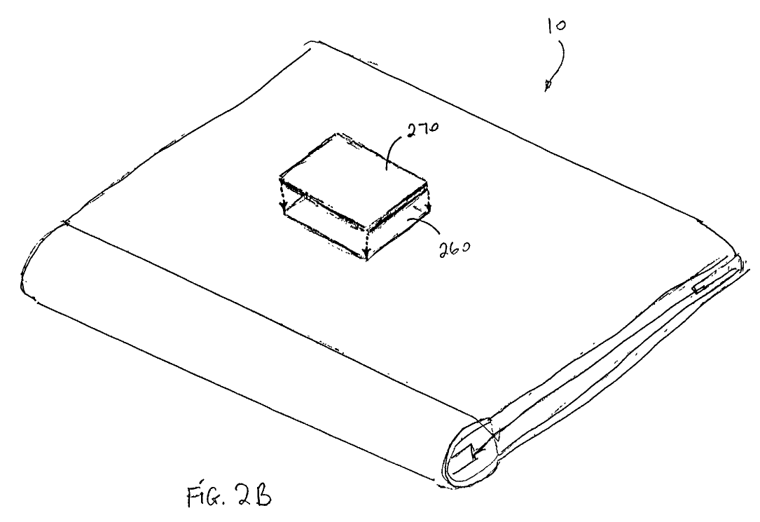

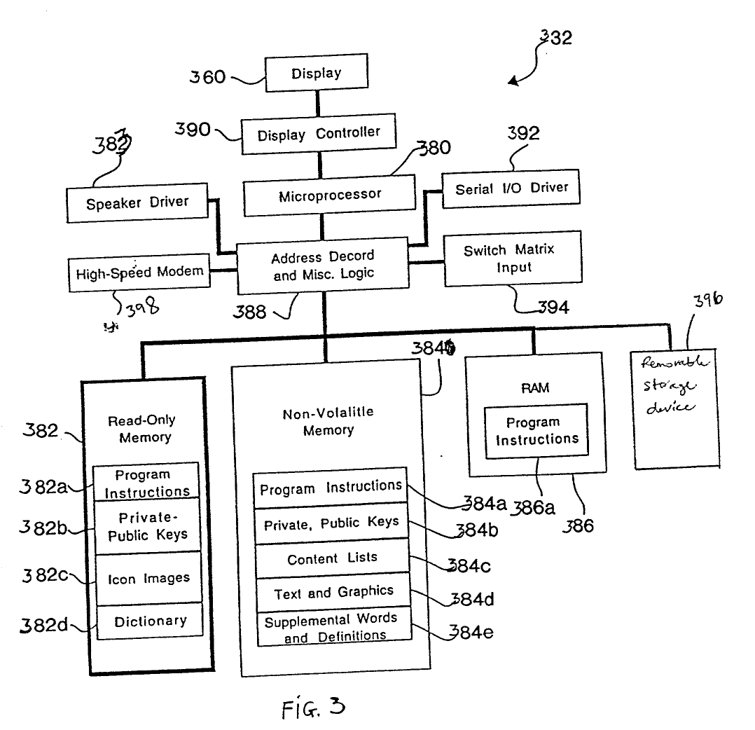

FIG. 2A shows a top perspective view of an electronic book 10 in accordance with one embodiment of the present invention. The electronic book 10 includes a housing 210, a battery holder 215, a cover 220, a display screen 230, a page turning mechanism 240, a menu key 250, a bookshelf key 252, and a functional key 254.

The housing 210 provides overall housing structure for the electronic book 10, including the housing for the electronic subsystems, circuits, and components of the overall system. The electronic book 10 is intended for portable user; therefore, the power supply is mainly from batteries. The battery holder 215 is attached to the housing 210 at the spine of the electronic book 10. Other power sources such as AC power can also be derived from interface circuits located in the battery holder 215. The cover 220 is usually made by flexible material and is attached to the housing 210. The cover is used to protect the viewing area 230.

The display screen 230 provides a viewing area for the user to view the electronic reading materials retrieved from the storage devices or downloaded from the communication network. The display screen 230 may be sufficiently lit so that the user can read the screen 230 without the aid of other light sources. When the electronic book is in use, the user interacts with the electronic book via a soft menu 232. The soft menu displays icons allowing the user to select functions. Examples of these functional icons include go, views, search, pens, bookmarks, markups, and close. Each of these functional icons may also include additional items. These additional items are displayed in a drop-down tray when the corresponding functional icon or key is activated by the user. An example of a drop-down tray is the pens tray which includes additional items such as pen, highlighter, and eraser. In one embodiment, the soft menu 232 can be updated dynamically and remotely via the communication network.

The page turning mechanism 240 can be used to turn the page either backward or forward. The page turning mechanism 240 may be implemented by a mechanical element with a rotary action. When the element is rotated in one direction, the electronic book will turn the pages in one direction. When the element is turned in the opposite direction, the electronic book will also turn in the opposite direction. In one embodiment, the page turner mechanism 240 may also be used as a latch to hold the cover 220 in place when the electronic book is closed.

The menu key 250 is used to activate the soft menu 232 and to select the functional icons. The bookshelf key 255 is used to display the contents stored in the bookshelf and to activate other bookshelf functions. The functional key 254 is used for other functions.

FIG. 2B shows a bottom perspective view of an electronic book 10 in accordance with one embodiment of the present invention. The electronic book 10 includes a slot or cavity adapted to receive and interface with a removable storage device. In one embodiment, the removable storage device 270 is a standard flash memory card capable of cooperating with standard digital cameras to store electronic images or photographs generated by the digital cameras.

FIG. 3 is a block diagram showing components of the electronic book 10, shown in FIGS. 2A and 2B. The electronic book is controlled by a microprocessor or central processing unit (CPU) 380 capable of executing program instructions 382a, 384a, 386a as well as reading data from Read Only Memory (ROM) 382, non-volatile Random Access Memory (NVRAM) 384b, Random Access Memory (RAM) 386, or a removable storage device 396 such as a flash memory card. In one embodiment, the removable storage device 396 stores electronic images or photographs generated by standard digital cameras.

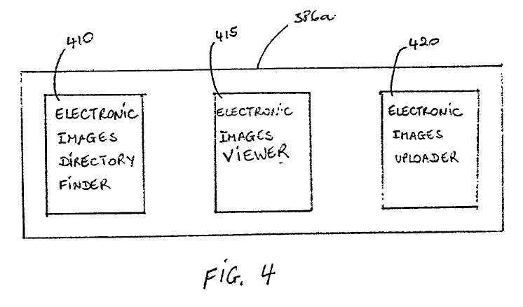

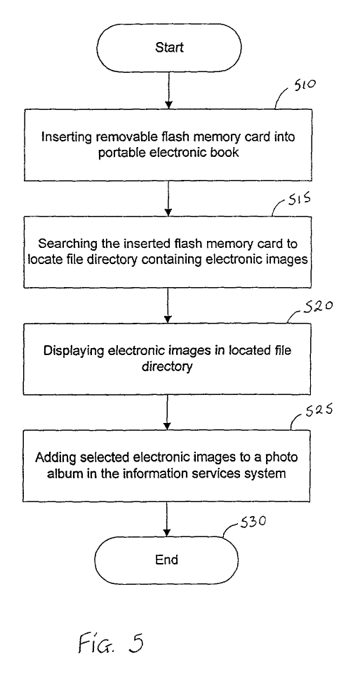

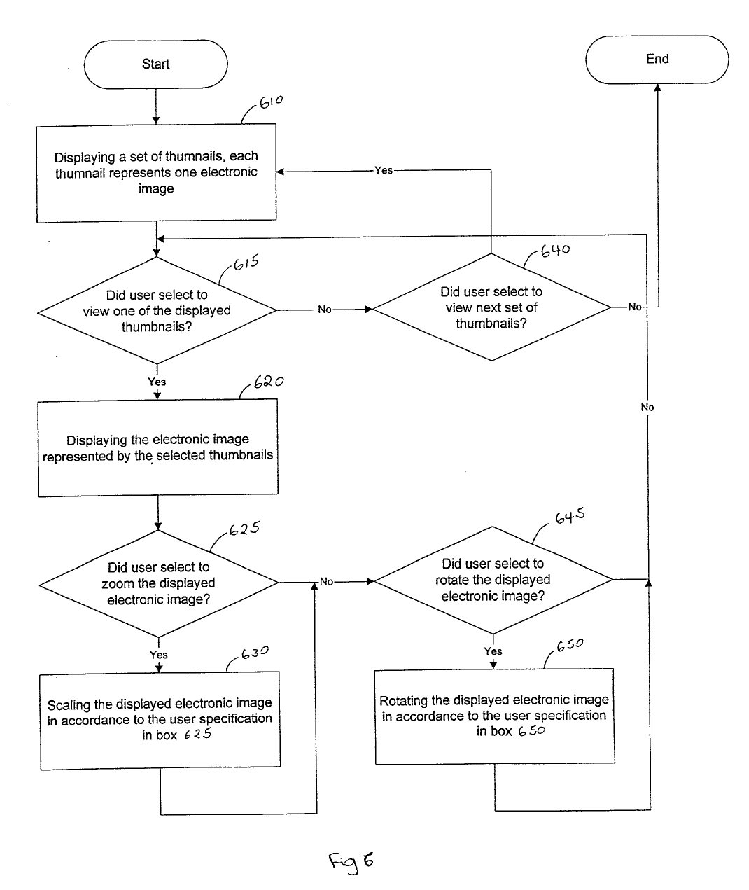

The program instructions 382a, 384a, 386a located in ROM 382, NVRAM 384, and RAM 386 respectively, provide the control for all the device operations of the electronic book. In one embodiment, program instructions 386a in RAM 386 includes modules generally used to read and manipulate electronic images or photographs stored in the removable storage device 396. In this embodiment, the modules include an electronic images directory finder 410, an electronic images viewer 415, and an electronic images uploader 420 (shown in FIG. 4). Electronic images directory finder 410 can be used to locate the file directory on the flash memory card where electronic images can be found. In one embodiment, the file directory as well as files stored in the directory conform to the standard DOS format. Electronic images viewer 415 can be used to present electronic images to users via the display screen 232 (shown in FIG. 2A). Electronic images uploader 420 can be used to upload electronic images stored in the flash memory card to a photo album in the information services system 20, (shown in FIG. 1). More details on the inter-operability of the electronic images directory finder 410, the electronic images viewer 415, and the electronic images uploader 420 will be provided below in FIGS. 5, 6, 7, and 8 and the description of those figures.

Returning to FIG. 3, CPU 380 is coupled to address decode circuit 388, which also comprises miscellaneous logic circuitry. Address decode circuit 388, performs address decoding and is coupled to a speaker driver 383, a serial I/O driver 392, function switches 394, and a high-speed modem 398. Speaker driver 383 drives speakers (not shown) connected to the electronic book.

Serial I/O driver 392 drives I/O devices such as a printer (not shown). A printer may be connected to the electronic book via the serial I/O driver 392 to enable the production of hard copies of reading materials stored in the memory of the electronic book or electronic images or photographs stored in the removable storage device 396. Switches 394 are used for selecting icons displayed on the display screen. Alternatively, the switches 394 may exist as a touch-sensitive overlay on top of the display screen of the electronic book.

Modem 398 may be internal or external to the electronic book, and is used to communicate with other elements of the information services system 100, shown in FIG. 1. For secure data transactions, public and private keys 382b, 384b are used. Public and private keys 382b, 384b are stored either in ROM 382 or NVRAM 384 respectively.

FIG. 5 generally outlines the process of displaying electronic images or photographs stored in a flash memory card, and adding those electronic images or photographs to a photo album in the information services system 20 (shown in FIG. 1A). In block 510, a flash memory card is inserted into the slot or cavity, which is located on the back of the portable electronic book and is adapted to receive and interface with the memory card. In block 515, the electronic images directory finder searches the inserted flash memory card to locate the file directory which contains the electronic images or photographs. In one embodiment, the file directory and electronic images or photographs stored under the directory conform to the standard DOS format. In block 520, electronic images or photographs stored under the located file directory are displayed or presented to the user.

FIG. 6 generally outlines the process of displaying or presenting electronic images to the user. In block 610, the electronic images viewer displays or presents a set of thumbnails to the user. Each of the displayed thumbnails represents one electronic image or photograph stored under the located file directory.

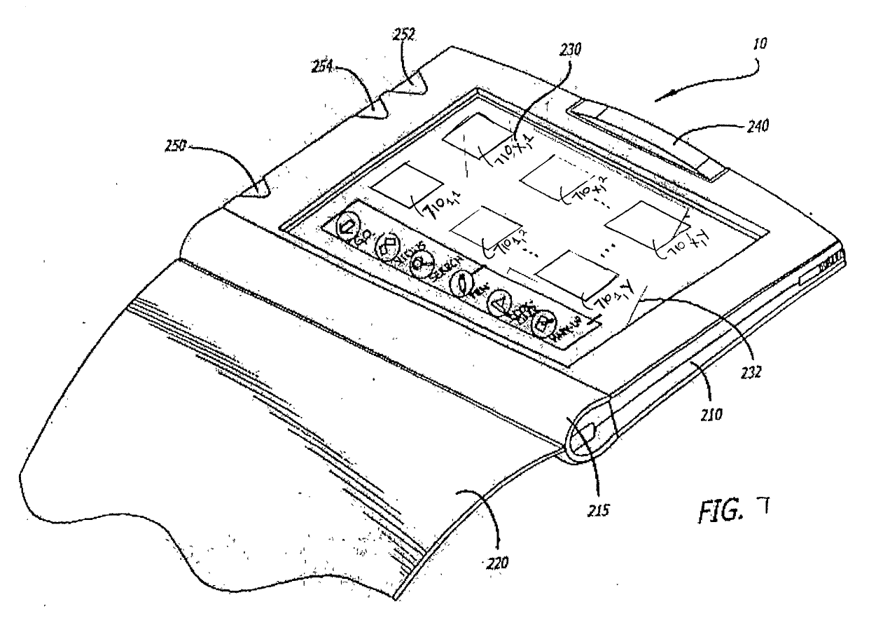

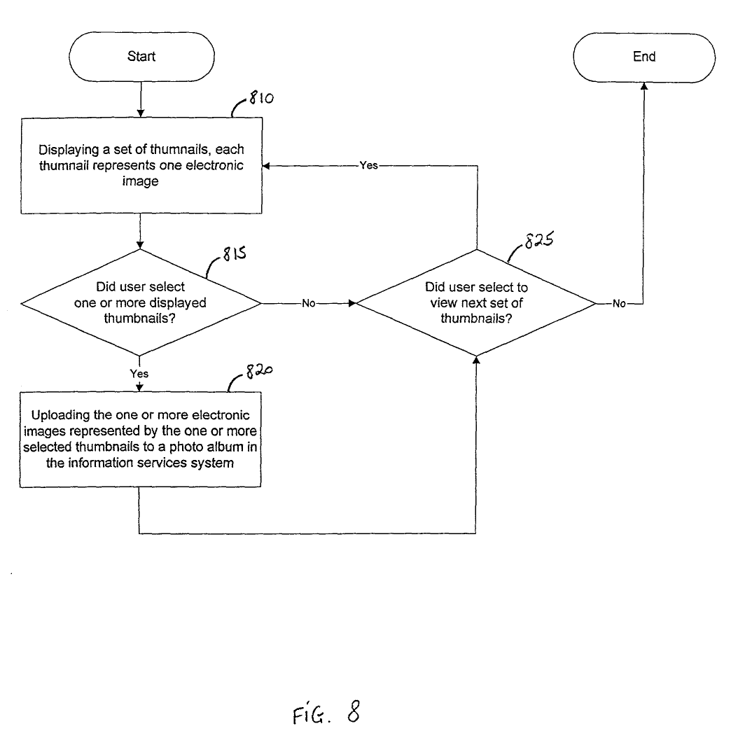

FIG. 7 illustrates an exemplary configuration in which thumbnails 710_{1,1}, . . . , 710_{x,1}, 710_{1,2}, . . . , 710_{x,2}, 710_{1,y}, . . . , 710_{x,y}, where “X” and “Y” are positive integers, are displayed or presented to the user via the display screen 232 of the portable electronic book 10. In one embodiment, the user can utilize the page turning mechanism 240 to scroll from one set of thumbnails to the next set of thumbnails. It should be noted that the scrolling action can be done backward or forward. As stated above, the page turning mechanism 240 may be implemented by a mechanical element with a rotary action.

Returning to FIG. 6, a query is made to determine whether the user has selected to view a displayed thumbnail (block 615). If the user selected to view a selected thumbnail, the electronic image represented by the thumbnail is displayed (block 620). A query is then made in block 625 to determine whether the user has selected to zoom in or out the displayed electronic image. If the user wants to zoom the displayed electronic image, the image is scaled in accordance to the user zoom selection (block 630), and control is transferred to block 645. If the user does not want to zoom the displayed electronic image, control is transferred to block 645.

In block 645, a query is made to determine whether the user wishes to rotate the displayed electronic image or photograph. If the user wishes to rotate the displayed electronic image, the image is rotated in accordance to the user rotation selection (block 650), and control is transferred to block 615. If the user does not want to rotate the display electronic image, control is transferred to block 615.

Returning to block 615 of FIG. 6, if the user does not wish to view a displayed thumbnail, a query is made to determine whether the user wishes to view the next set of thumbnails (block 640). If the user wishes to view the next set of thumbnails, control is transferred to block 610. If the user does not wish to view the next set of thumbnails, the process of displaying or presenting electronic images to the user is completed and ended, and control is transferred to block 525 of FIG. 5.

Returning to block 525 of FIG. 5, the electronic images uploader adds selected electronic images to a photo album in the information services system 20 (shown in FIG. 1A).

FIG. 8 outlines the process of adding selected electronic images to a photo album in the information services system 20 (shown in FIG. 1A). In block 810, the electronic images viewer displays or presents a set to thumbnails to the user. Each of the displayed thumbnails represents one electronic image or photograph stored under the located file directory. In block 815, a query is made to determine whether the user selected any of the displayed thumbnails.

If the user did not select any thumbnails, control is transferred to block 825. If the user selected one or more thumbnails, one or more electronic photographs represented by the one or more selected thumbnails is uploaded to a photo album in the information services system 20 (shown in FIG. 1A). Control is then transferred to block 825.

In block 825, a query is made to determine whether the user wishes to view the next set of thumbnails. If the user does not wish to view the next set of thumbnails, the process of adding or uploading selected electronic images to a photo album is completed, and control is transferred to block 530 of FIG. 5. If the user wishes to view the next set of thumbnails, control is transferred to block 810.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A system to distribute electronic publications, comprising:
a portable electronic book adapted to receive and interface with a removable storage device storing electronic photographs generated by a digital camera; and
an information services system including a centralized bookshelf and a personal photo albums module associated with the portable electronic book, the centralized bookshelf including electronic reading materials requested and owned by the portable electronic book, the personal photo albums module including electronic photographs owned by the portable electronic book.

2. The system of claim 1, wherein the portable electronic book extracts the electronic photograph from the removable storage device and upload the electronic photograph to the personal photo albums module.

3. The system of claim 1, wherein the removable storage device is a flash memory card.

4. The system of claim 1, wherein the electronic photographs are JPEG (Joint Photographic Experts Group) files.

5. The system of claim 1, wherein the personal photo albums module includes a plurality of photo albums, and each of the plurality of photo albums is capable of storing a plurality of electronic photographs.

6. The system of claim 1, wherein the portable electronic book displays thumbnails to a user, each of the thumbnails represents one electronic photograph stored on the removable storage device.

7. The system of claim 6, wherein the portable electronic book includes a page turning mechanism to enable a user to scroll through different sets of thumbnails.

8. The system of claim 1, wherein the portable electronic book scales an electronic photograph selected from the electronic photographs stored on the removable storage device.

9. The system of claim 1, wherein the portable electronic book rotates an electronic photograph selected from the electronic photographs stored on the removable storage device.

10. The system of claim 1, wherein the portable electronic book communicates with the information services system through an electrical communication link.

11. The system of claim 10, wherein the electrical communication link is established via a high-speed modem.

12. A method to distribute electronic publications, comprising:
inserting a removable storage device into a portable electronic book, the removable storage device containing electronic photographs generated by a digital camera; and
uploading the electronic photographs to an information services system, the information services including a centralized bookshelf and a personal photo albums module associated with the portable electronic book, the centralized bookshelf including electronic reading materials requested and owned by the portable electronic book, the personal photo albums module including electronic photographs owned by the portable electronic book.

13. The method of claim 12, further comprising retrieving the electronic photographs from the removable storage device.

14. The method of claim 12, further comprising storing the electronic photographs on the removable storage device as JPEG (Joint Photographic Experts Group) files.

15. The method of claim 12, further comprising including a plurality of photo albums in the personal photo albums module, wherein each of the plurality of photo albums is capable of storing a plurality of electronic photographs.

16. The method of claim 12, further comprising displaying thumbnails on a display screen of the portable electronic book, wherein each of the thumbnails represents one electronic photograph stored on the removable storage device.

17. The system of claim 16, further comprising scrolling through different sets of thumbnails using a page turning mechanism on the portable electronic book.

18. The system of claim 12, further comprising scaling an electronic photograph selected from the electronic photographs stored on the removable storage device.

19. The system of claim 12, further comprising rotating an electronic photograph selected from the electronic photographs stored on the removable storage device.

20. The system of claim 12, further comprising establishing an electrical communication link to enable the portable electronic book to communicate with the information services system.

21. The system of claim 20, further comprising using a high-speed modem to testable the electrical communication link between the portable electronic book and the information services system.
